(19) United States
(12) Patent Application Publication
(10) Pub. No.: US 2025/0056598 A1
(43) Pub. Date: Feb. 13, 2025

(54) MULTI-CARRIER/BEAM LBT PROCEDURE ABOVE 52.6GHZ

(71) Applicant: Intel Corporation, Santa Clara, CA (US)

(72) Inventors: Salvatore Talarico, Los Gatos, CA (US); Yi Wang, Beijing (CN); Yingyang Li, Beijing (CN); Gang Xiong, Beaverton, OR (US); Dae Won LEE, Portland, OR (US)

(21) Appl. No.: 18/723,547

(22) PCT Filed: Feb. 9, 2023
(86) PCT No.: PCT/US2023/012692

§ 371 Date: Jun. 24, 2024

Related U.S. Application Data
(60) Provisional application No. 63/309,401, filed on Feb. 11, 2022.

(51) Int. Cl. H04W 74/00; H04W 74/0808

(52) U.S. Cl. CPC H04W 74/006; H04W 74/0808

(57) ABSTRACT

An apparatus and system of providing a listen before talk (LBT) procedure in multi-carrier or multi-beam mode above a 52.6 GHz band are described. The LBT procedure is performed independently for each carrier or beam to maintain and update a different back-off counter for each carrier or beam. To align a transmission starting time across the carriers or beams, for each carrier or beam: the counter continues to decrement if the counter has reached zero before the starting time and transmit at the starting time if the channel continues to be sensed idle for an additional observation period immediately prior to the starting time and otherwise considers the LBT procedure to have failed. The counter is reinitialized for carriers or beams for which a channel occupancy time (COT) is to be acquired and transmission ceases.

### PRIORITY CLAIM

This application claims the benefit of priority to U.S. Provisional Patent Application Ser. No. 63/309,401, filed Feb. 11, 2022, which is incorporated herein by reference in its entirety.

### TECHNICAL FIELD

Embodiments pertain to wireless communications. In particular, some embodiments relate to multi-carrier and multi-beam listen before talk (LBT) procedures for above the 52.6 GHz band.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to communications using higher bands. In particular, carrier use above 52.6 GHz may be subject to complex LBT procedures.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates acquisition of independent COTs at different instances of time for each beam in accordance with some embodiments.

FIG. 4 illustrates reference signal transmission in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

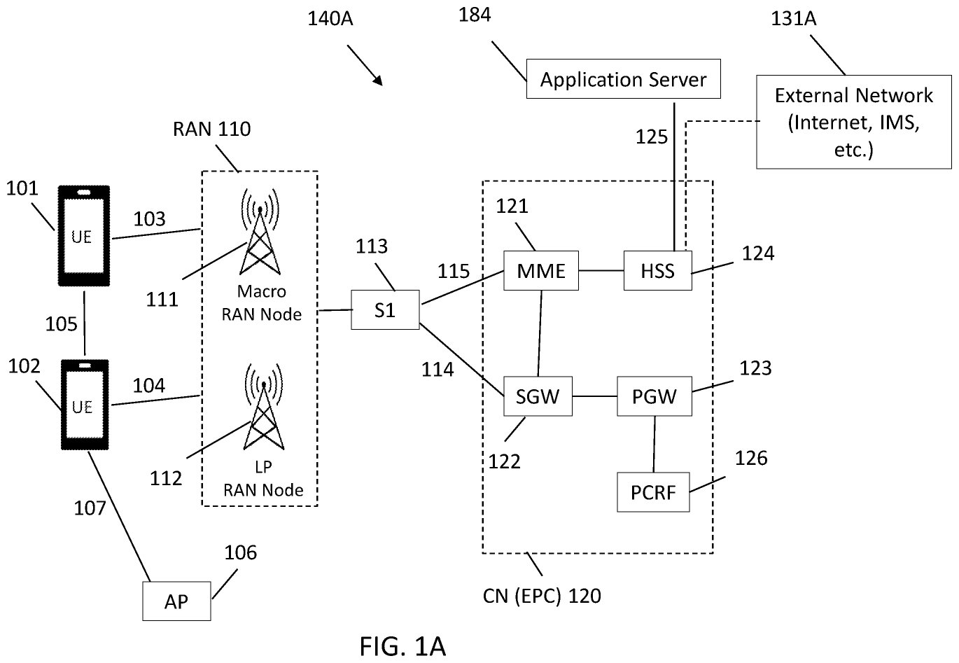

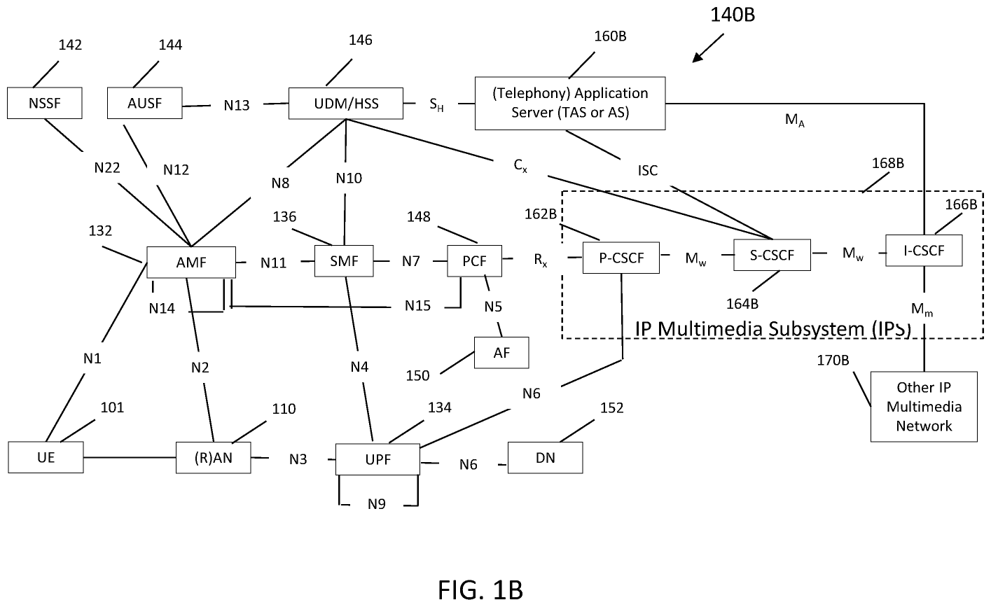

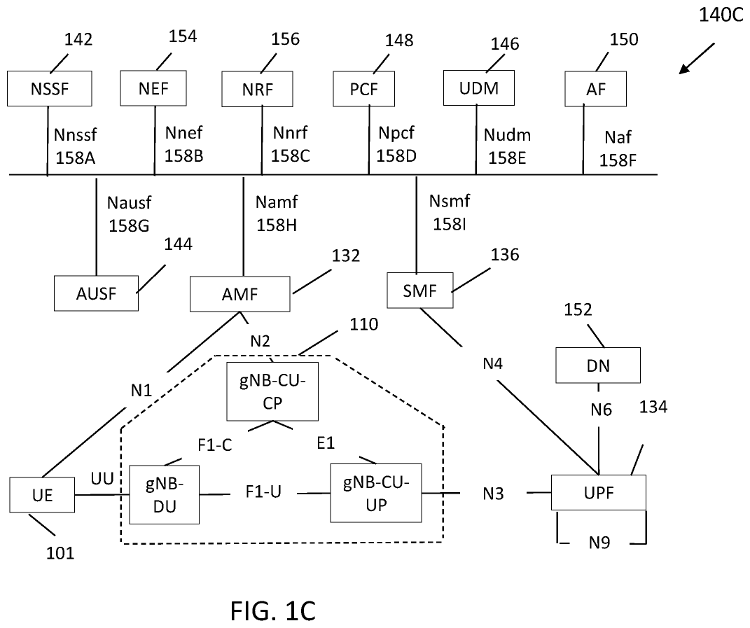

FIG. 1A illustrates an architecture of a network in accordance with some aspects. The network 140A includes 3GPP LTE/4G and NG network functions that may be extended to 6G and later generation functions. Accordingly, although 5G will be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signalling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signalling connection and UE-associated services that are related to a single UE and are associated with a UE-associated signalling connection that is maintained for the UE.

The F1 interface may be disposed between the CU and the DU. The CU may control the operation of the DU over the F1 interface. As the signalling in the gNB is split into control plane and user plane signalling, the F1 interface may be split into the F1-C interface for control plane signalling between the gNB-DU and the gNB-CU-CP, and the F1-U interface for user plane signalling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signalling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

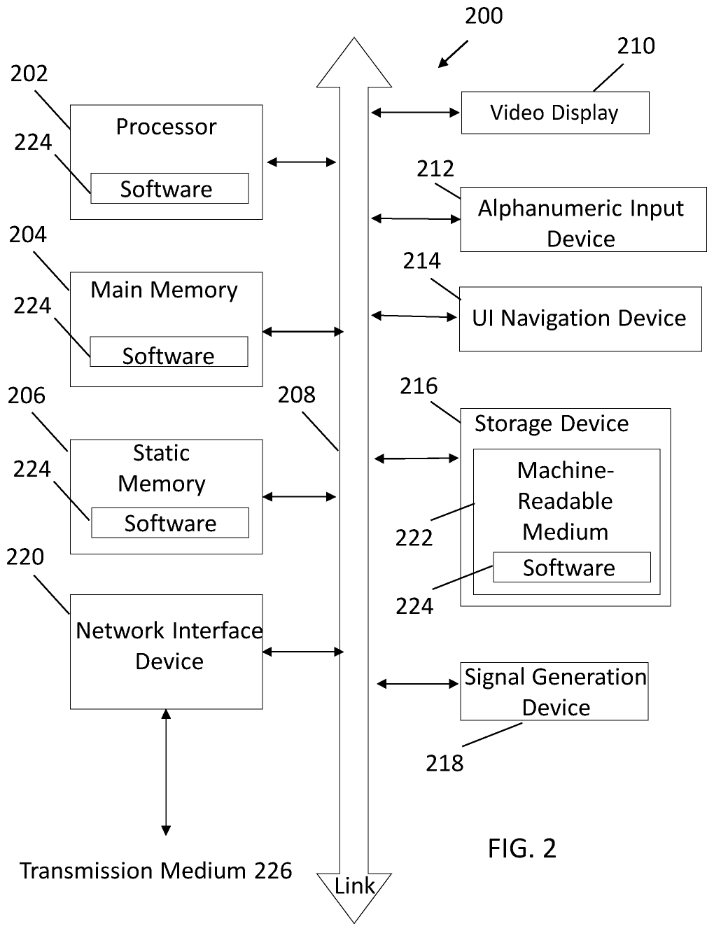

FIG. 2 illustrates a block diagram of a communication device in accordance with some embodiments, such as an evolved Node-B (eNB), a new generation Node-B (gNB) (or another RAN node), an access point (AP), a wireless station (STA), a mobile station (MS), or user equipment (UE), in accordance with some aspects and to perform one or more of the techniques disclosed herein. In alternative aspects, the communication device 200 may operate as a standalone device or may be connected (e.g., networked) to other communication devices. The communication device may be any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.1 lad, IEEE 802.1 lay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., lowithmedium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs—note that this term is typically used in the context of 3GPP 5G and 6G communication systems, etc. Still, a UE may take this role as well and act as an AP, eNB, or gNB; that is some or all features defined for network equipment may be implemented by a UE.

As above, NR support of high frequency communications (from 52.6 GHz to 71 GHz) has been approved. This support includes establishment of the physical layer procedures including: a channel access mechanism assuming beam-based operation in order to comply with the regulatory requirements applicable to the unlicensed spectrum for frequencies between 52.6 GHz and 71 GHz; specification of both LBT and no-LBT related procedures (for no-LBT case no additional sensing mechanism is specified); specification of omni-directional LBT, directional LBT and receiver assistance in channel access; and specification of energy detection threshold enhancements.

In particular, since a large component of the 52.6-71 GHz band is unlicensed spectrum, any design is to comply with the worldwide regulatory requirement within this band. In this matter Table I summarizes the regions and the related available unlicensed bands, also providing a high level summary of the regulatory requirements to be met in each region to operate in those bands.

| ITU-R | Region 1 | | | | | | Region 3 | | | | | |
|---|---|---|---|---|---|---|---|---|---|---|---|---|
| Regions | Europe/ | South | Region 2 | | | | | | South | | | |
| Countries | CEPT | Africa | USA | Canada | Brazil | Mexico | China | Japan | Korea | India | Singapore | Australia |
| Band | 57-71 | 57-66 | 57-71 | 57-64 | 57-64 | 57-64 | 59-64 | 57-66 | 57-66 | 61-61.5 | 57-66 | 57-66 |
| (GHz) | | | | | | | | | | | | |
| Max | 40 | 40 | 40 | 40 | 27 | | 44 | 40 | 27 | 20 | | |
| Avg. | dBm | dBm | dBm | dBm | dBm | | dBm | dBm | dBm | dBm | | |
| EIRP | | | | | | | | | | | | |
| PSD | 23 | | | | | | | | 13 | | | |
| (dBm/ | | | | | | | | | | | | |
| MHz) | | | | | | | | | | | | |
| Max | | | 43 | 43 | | 85 | 47 | <=24 | 43 | | 40 | 43 |
| Peak | | | | | | | | | | | | |
| EIRP | | | | | | | | | | | | |
| (dBm) | | | | | | | | | | | | |
| OCB | [70% | [70% | | | | | | <9 GHz | Within | | | |
| | to | to | | | | | | | 57 | | | |
| | 100%] | 100%] | | | | | | | to | | | |
| | | | | | | | | | 66 | | | |
| | | | | | | | | | GHz | | | |
| Spectrum | LBT | | | | | | | LBT | | | | |
| access | | | | | | | | for | | | | |
| | | | | | | | | TX | | | | |
| | | | | | | | | power | | | | |
| | | | | | | | | >10 dBm | | | | |

Given that there are regions (e.g., Europe/CEPT) that require the use of the LBT procedure, RANi has agreed to allow the network to configure the use of this procedure so that the network is able to use the LBT procedure when mandated or when the LBT procedure would be beneficial to boost system performance.

The LBT procedure may be utilized either when the system operates in multi-carrier mode or when multiple user multiple input multiple output (MIU-MIMO) or time domain multiplexing (TDM) of beams is employed within a channel occupancy time (COT).

For multi-carrier mode, a gNB or UE may acquire a COT by performing multiple LBTs, one of each channel bandwidth. In this case, only a Type A-like multi-carrier channel access mode may be supported, where Cat-4 (used by the gNB or UE to initiate a COT for transmissions—with random back-off and a variable extended CCA period, randomly drawn from a variable-sized contention window, whose size can vary based on channel dynamics) is performed on each carrier. Whether legacy mechanisms such as type A1 is supported is to be determined.

As for the case of operation in multi-beam mode, the following agreements have been reached. First, within a COT with TDM of beams with beam switching, one or more of the following LBT operations may be used: Alt 1—a single LBT sensing with wide beam that covers all beams to be used in the COT with an appropriate energy detection (ED) threshold; Alt 2—independent per-beam LBT sensing at the start of COT is performed for beams used in the COT; and/or Alt 3—independent per-beam LBT sensing at the start of COT is performed for beams used in the COT with an additional requirement on Cat 2 LBT before a beam switch.

Second, within a COT with TDM of beams with beam switching, when independent per-beam LBT sensing at the start of COT is performed for beams used in the COT (alt 2 or 3 above) is considered, the following alternatives are further considered: Alt A: the per-beam LBT for different beams is performed one after another in time domain; Alt A-1: the node completes one extended clear channel assessment (eCCA) on one beam, and directly moves on to the eCCA on the other beam, with no transmission in the middle; Alt A-2: the node completes one eCCA on one beam, starts transmission with the beam to occupy the COT, then moves on to the eCCA on the other beam; Alt A-3: the node performs eCCA of the different beams simultaneously, round robin between different beams; Alt B: the per-beam LBT for different beams is performed simultaneously in parallel, assuming the node has the capability to simultaneously sense in different beams.

Third, within a COT with TDM of beams with beam switching, at least support Alt 1 (from the previous agreement): a single LBT sensing with wide beam ‘cover’ all beams to be used in the COT.

Fourth, within a COT with TDM of beams with beam switching, Alt 2 is supported if the node has the capability to perform simultaneous sensing in different beams. Alt 3 is allowed as a node implementation choice if the node also supports Cat 2 LBT. The use of Alt 2 or Alt 3 is based on the node's implementation. Alt 2 from the previous agreement: independent per-beam LBT sensing at the start of COT is performed for beams used in the COT. Alt 3 from the previous agreement: independent per-beam LBT sensing at the start of COT is performed for beams used in the COT with an additional requirement on Cat 2 LBT before a beam switch.

However, for the case when independent per-beam LBT is performed to initiate a multi-beam COT with TDMed and spatial domain multiplexed (SDMed) transmission beams, the details on how the overall procedure may work have not been yet established. With that said, various different options are disclosed herein on how the LBT procedure may be performed for both multi-carrier and multi-beam operation when per-beam LBT is performed to acquire a COT.

### Multi-Carrier Channel Access Procedure

Multi-carrier operation was introduced in Rel. 16 NR, and similar to LTE, two alternative solutions were introduced to cope with multi-carrier LBT: type A and type B operation.

Type A: the gNB performs Cat-4 LBT on each carrier. In order to align the transmissions across carriers, the gNB performs a self-deferral. For this type of operation, the gNB may:

Type A1: maintain a contention window size (CWS) counter and perform CWS adjustment independently for each carrier. In this case, if the gNB ceases transmission over one carrier, the gNB resumes to decrease the counter for all other carriers if the channel is idle for 4 CCA or after reinitializing the value of the counter.

Type A2: maintain a common CWS counter and perform a common CWS adjustment for all the carriers. The CWS adjustment is performed by associating the highest CWS value across carriers to all carriers. In this case, if gNB ceases transmission over one carrier, then the gNB reinitializes the counter for all carriers.

Type B: the gNB selects a single carrier by either uniformly picking in a random fashion one carrier across all carriers or by configuring a specific carrier to operate as a so called “primary channel”. A primary channel cannot be changed more than once every predetermined period (e.g., second). The gNB can perform sensing over the other carriers by applying a Cat-2 LBT only if the gNB completes the Cat-4 LBT for the primary channel. For this type of operation, the gNB may:

Type B1: maintain a CWS counter and perform CWS adjustment independently for each carrier. In this case, the single carrier mechanism is used with the distinction that a CWS is increased if a negative acknowledgement (NACK) is determined in all carriers within the reference subframe.

Type B2: maintain a common CWS counter and perform a common CWS adjustment for all the carriers.

As mentioned above, for NR operating above the 52.6 GHz band, a device is also able to operate in multiple-carrier mode, and only a type A-like multi-carrier channel access mode may be supported. While the type A procedure is defined for sub-6 GHz band operation, where the concept of channel access priority class and contention window adjustment was introduced, and Cat-4 LBT was used, such a procedure is no longer relevant above the 52.6 GHz band where a type 1 LBT has been defined for which the contention window is fixed. Therefore, changes are used to operate a type A channel access procedure above the 52.6 GHz band—and the overall procedure may deviate from the original sub-6 GHz band design.

Accordingly, in one embodiment, for above the 52.6 GHz band when a system operates in multi-carrier mode and a device performs LBT to acquire the channel, a type 1 LBT may be independently performed in each carrier, which indicates that a device may maintain and update independently the back-off counter for each carrier. For example, if a device intends to perform a transmission over two carriers, two independent LBTs are performed: one for the first carrier and the second for the second carrier. Each of these LBT are independently performed, and a device may both draw an independent counter for each of the LBT, and update the counters based on the measurements performed on each carrier.

Alternatively, a single counter may be maintained for all the carriers, and the counter may be decreased if, for each observation period of 8 μs, one of the following options is satisfied: the channel has been assessed to be idle for all the carriers; the channel has been assessed to be idle for at least one of the carriers; or the channel has been assessed to be idle for at least X % of the total number of carriers.

If a device may maintain independent back-off counters for each carrier, the LBT procedure may end on different time instances. In this matter, in order to make sure that a device does not transmit on one carrier while performing LBT on another, the starting time of a transmission is aligned across the carriers over which the device is performing LBT.

In one embodiment, for above the 52.6 GHz band when a system operates in multi-carrier mode and a device performs LBT to acquire the channel, in order to align the starting time of a transmission across carriers, a device performing independent LBTs whose backoff counter is indicated by N_{C}_{ᵢ} for a carrier Cᵢ behaves as follows: if the backoff counter N_{C}_{ᵢ} for a carrier Cᵢ reaches zero before the aligned transmission starting time, the device continues to decrement the counter N_{C}_{ᵢ} (meaning that the device continues to sense the channel via additional observation periods of 5 μs or 8 μs each) and transmits in the corresponding carrier at the aligned start time if the channel continues to be sensed idle in all of the additional sensing slot durations; if the backoff counter N_{C}_{ᵢ} for a carrier Cᵢ does not reach zero before the aligned start time, or reaches zero but the channel has been sensed busy in any of the additional sensing slot durations, the channel access procedure in carrier Cᵢ is considered to have failed.

In another embodiment, for above the 52.6 GHz band when a system operates in multi-carrier mode and a device performs LBT to acquire the channel, in order to align the starting time of a transmission across carriers, a device performing independent LBTs whose backoff counter is indicated by N_{C}_{ᵢ} for a carrier Cᵢ behaves as follows: if the backoff counter N_{C}_{ᵢ} for a carrier Cᵢ reaches zero before the aligned transmission starting time, the device continues to decrement the counter N_{C}_{ᵢ} (meaning that the device continues to sense the channel via additional observation periods of 5 μs or 8 μs each) and transmits in the corresponding carrier at the aligned start time if the channel continues to be sensed idle in all of the additional sensing slot durations or if the channel was sensed to be idle at least X observations periods before the aligned start time, where X is fixed (e.g., X=1, 2, 3 or 4) or X can be left up to implementation; if the backoff counter N_{C}_{ᵢ} for a carrier Cᵢ does not reach zero before the aligned start time, or reaches zero but the channel has been sensed busy in any of the additional sensing slot durations or if reaches zero but the channel has been sensed busy X observations periods before the aligned start time, then the channel access procedure in carrier Cᵢ is considered to have failed.

In another embodiment, for above the 52.6 GHz band when a system operates in multi-carrier mode and a device performs LBT to acquire the channel, in order to align the starting time of a transmission across carrier, a device performing independent LBTs whose backoff counter is indicated by N_{C}_{ᵢ} for a carrier Cᵢ behaves as follows: if the backoff counter N_{C}_{ᵢ} for a carrier Cᵢ reaches zero before the aligned transmission starting time, the device does not continue to decrement the counter N_{C}_{ᵢ} and the channel access procedure in carrier Cᵢ is considered to have succeeded, and once the device transmits on that carrier starting from the transmission starting time; if the backoff counter N_{C}_{ᵢ} for a carrier Cᵢ does not reach zero before the aligned start time, then the channel access procedure in carrier Cᵢ is considered to have failed.

In another embodiment, for above the 52.6 GHz band when a system operates in multi-carrier mode and a device performs LBT to acquire the channel, in order to align the starting time of a transmission across carrier, a device performing independent LBTs whose backoff counter is indicated by N_{C}_{ᵢ} for a carrier Cᵢ behaves as follows: if the backoff counter N_{C}_{ᵢ} for a carrier Cᵢ reaches zero before the aligned transmission starting time, the device does not continue to decrement the counter N_{C}_{ᵢ} and can consider the channel access procedure to have succeeded in carrier Cᵢ only if by performing at least Y additional observations right before the transmission starting time the channel is assessed to be idle; if the backoff counter N_{C}_{ᵢ} for a carrier Cᵢ does not reach zero before the aligned start time, or if the backoff counter N_{C}_{ᵢ} for a carrier Cᵢ reaches zero before the aligned start time but any of the N additional observations performed right before the transmission starting time assess that the channel is idle, then the channel access procedure in carrier Cᵢ is considered to have failed.

In one option of this embodiment, the maximum COT (MCOT) is counted from one of the following: the starting time of the transmission; or the instance of time when at least one of the LBT succeeds over a carrier.

In another embodiment, for above the 52.6 GHz band when a system operates in multi-carrier mode and a device performs LBT to acquire the channel, in order to align the starting time of a transmission across carriers, a device performing independent LBTs whose backoff counter is indicated by N_{C}_{ᵢ} for a carrier Cᵢ behaves as follows: the device transmits on carrier Cᵢ starting from the transmission starting time only if the backoff counter N_{C}_{ᵢ} for a carrier Cᵢ reaches zero right at the start of the aligned transmission starting time; otherwise, the channel access procedure in carrier Cᵢ is considered to have failed.

In one embodiment, for above the 52.6 GHz band when a system operates in multi-carrier mode, a device performs LBT to acquire the channel, and maintains independent counters for each carrier; if the device ceases transmission in any of the carriers over which the device has performed LBT, then the device reinitializes the counter for all the carriers.

In one embodiment, for above the 52.6 GHz band when a system operates in multi-carrier mode and a device performs LBT to acquire the channel, if the device ceases transmission in any of the carriers over which the device has performed LBT, then the device reinitializes the counter only for those carriers for which the device was able to cease transmission.

The examples/embodiments listed above are not mutually exclusive, and one or more may apply together or may be combined.

### Multi-beam Channel Access Procedure

As mentioned above, for NR operating above the 52.6 GHz band, a device can acquire a COT over multiple beams, and in doing so the device can either perform a single wide-beam LBT that covers all the beams for which a COT is to be acquired, or the device can perform independent per-beam LBT individually over each of the beams for which a COT is to be acquired. The details of the last procedure have not been defined, and there are several considerations of note.

In one embodiment, for above the 52.6 GHz band when a device is to perform independent per-beam LBT over each beam for which a COT is to be acquired, a device may drop a transmission if one of the following is satisfied: a device may drop a transmission if the independent per-beam LBT procedure fails on at least one of the beams over which a device intends to acquire the channel and transmit; or a device may drop a transmission if the independent per-beam LBT procedure fails on all the beams over which a device intends to acquire the channel, otherwise a COT is considered to be acquired for any beams for which the independent per-beam LBT procedure succeeded.

Whether or not a transmission may be dropped based on the independent per-beam LBT procedure on each individual beams, the independent per-beam LBT procedure may end on different time instances, and a device may determine whether or not the transmission has succeeded at different times. Therefore, the determination may be made at a specific time, which may be the actual starting time of a transmission. This, as discussed above for the case of multi-carrier operation, is something also to be determined in this context to prevent a device from transmitting on a beam while performing LBT on another, as the combination of transmission and LBT may induce self-blocking.

In one embodiment, for above the 52.6 GHz band when a device is to perform independent per-beam LBT over each beams for which a COT is to be acquired, in order to align the starting time of a transmission across beams, a device performing independent LBTs whose backoff counter is indicated by N_{B}_{ᵢ} for a beam Bᵢ behaves as follows: if the backoff counter N_{B}_{ᵢ} for a beam Bᵢ reaches zero before the aligned transmission starting time, the device continues to decrement the counter N_{B}_{ᵢ} (meaning that the device continues to sense the channel via additional observation periods of 5 μs or 8 μs each) and assesses that the channel for that beam is clear at the aligned start time if the channel continues to be sensed idle in all of the additional sensing slot durations; if the backoff counter N_{B}_{ᵢ} for a beam Bᵢ does not reach zero before the aligned start time or reaches zero but the channel has been sensed busy in any of the additional sensing slot durations, channel access procedure in beam Bᵢ is considered to have failed.

In another embodiment, for above the 52.6 GHz band when a device is to perform independent per-beam LBT over each beam for which a COT is to be acquired, in order to align the starting time of a transmission across beams, a device performing independent LBTs whose backoff counter is indicated by N_{B}_{ᵢ} for a beam Bᵢ behaves as follows: if the backoff counter N_{B}_{ᵢ} for a beam Bᵢ reaches zero before the aligned transmission starting time, the device continues to decrement the counter N_{B}_{ᵢ} (meaning that the device continues to sense the channel via additional observation periods of 5 μs or 8 μs each) and assesses that the channel for that beam is clear at the aligned start time if the channel continues to be sensed idle in all of the additional sensing slot durations or if the channel was sensed to be idle at least X observations periods before the aligned start time, where X is fixed (e.g., X=1, 2, 3 or 4) or X can be left up to implementation; or if the backoff counter N_{B}_{ᵢ} for a beam Bᵢ does not reach zero before the aligned start time, or reaches zero but the channel has been sensed busy in any of the additional sensing slot durations or if reaches zero but the channel has been sensed busy X observations periods before the aligned start time, then the channel access procedure in beam Bᵢ is considered to have failed.

In another embodiment, for above the 52.6 GHz band when a device is to perform independent per-beam LBT over each beam for which a COT is to be acquired, in order to align the starting time of a transmission across beams, a device performing independent LBTs whose backoff counter is indicated by N_{B}_{ᵢ} for a beam Bᵢ behaves as follows: if the backoff counter N_{B}_{ᵢ} for a beam Bᵢ reaches zero before the aligned transmission startinge time, the device does not continue to decrement the counter N_{B}_{ᵢ} and the channel access procedure in beam Bᵢ is considered to have succeeded regardless of the transmission starting time; if the backoff counter N_{B}_{ᵢ} for a the beam Bᵢ does not reach zero before the aligned start time, then the channel access procedure in beam Bᵢ is considered to have failed.

In another embodiment, for above the 52.6 GHz band when a device is to perform independent per-beam LBT over each beam for which a COT is to be acquired, in order to align the starting time of a transmission across beams, a device performing independent LBTs whose backoff counter is indicated by N_{B}_{ᵢ} for a beam Bᵢ behaves as follows: if the backoff counter N_{B}_{ᵢ} for a beam Bᵢ reaches zero before the aligned transmission starting time, the device does not continue to decrement the counter N_{B}_{ᵢ} and can consider the channel access procedure to have succeeded in beam Bᵢ only if by performing at least N additional observations right before the transmission starting time the channel is assessed to be idle; if the backoff counter N_{B}_{ᵢ} for a beam Bᵢ does not reach zero before the aligned start time, or if the backoff counter N_{B}_{ᵢ} for a beam Bᵢ reaches zero before the aligned start time but any of the Y additional observations performed right before the transmission starting time assess that the channel is idle, then the channel access procedure in beam Bᵢ is considered to have failed.

In one option of this embodiment, the MCOT is counted from one of the following: the starting time of the transmission; or the instance of time when at least one of the LBT succeeds over a beam.

In another embodiment, for above the 52.6 GHz band when a device is to perform independent per-beam LBT over each beam for which a COT is to be acquired, in order to align the starting time of a transmission across beams, a device performing independent LBTs whose backoff counter is indicated by N_{B}_{ᵢ} for a beam Bᵢ behaves as follows: the device assesses that the channel is clear on beam BL starting from the transmission starting time if the backoff counter N_{B}_{ᵢ} for a beam Bᵢ reaches zero right at the start of the aligned transmission starting time; otherwise, the channel access procedure in beam Bᵢ is considered to have failed.

In one embodiment, for above the 52.6 GHz band when a device is to perform independent per-beam LBT over each beam for which a COT is to be acquired, if the device ceases transmission in any of the beams over which the device has performed LBT, then the device reinitializes the counter for all the carriers.

In one embodiment, for above the 52.6 GHz band when a device is to perform independent per-beam LBT over each beam for which a COT is to be acquired, if the device ceases transmission in any of the beams over which the device has performed LBT, then the device reinitializes the counter only for those carriers for which the device was able to cease transmission.

The examples/embodiments listed above are not mutually exclusive, and one or more of them may apply together or could be combined.

### COT Length Indication for Directional LBT

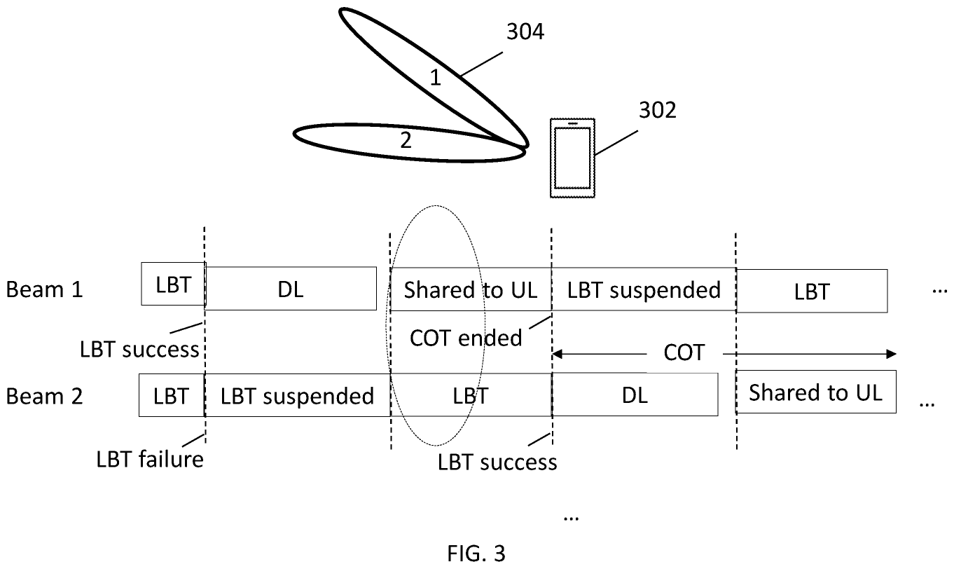

When directional LBT is used, and both wide-beam LBT and independent per-beam LBT is performed at the gNB, a UE is not aware in which beam or group of beams the LBT procedure has succeeded. Therefore, the gNB indicating in DCI 2_0 the remaining COT length may lead into ambiguity between the gNB and UE on which specific beam or group of beams the gNB has effectively acquired the COT and can share its COT with the UE. Furthermore, a gNB may potentially acquire independent COTs at different instances of time for each beam. FIG. 3 illustrates acquisition of independent COTs at different instances of time for each beam in accordance with some embodiments. In particular, FIG. 3 illustrates a system 300 in which a gNB 302 initiates two independent COTs on two different beams that serve a given UE 304 on different time instances.

In one embodiment, DCI 2_0 may be enhanced to indicate the control information per beam. A linkage may exist between the indication of a beam in DCI 2_0 and a Transmission Configuration Indication (TCI) state or Quasi Co-Location (QCL) assumption configured for the UE. The linkage can be 1-to-1 mapping, 1-to-many mapping, or many-to-1 mapping. Further, a linkage exists between the indication of a beam in DCI 2_0 and a sounding reference signal (SRS) resource indicator (SRI) configured for the UE. The linkage may be 1-to-1 mapping, 1-to-many mapping or many-to-1 mapping. The linkage may be configured by high layer signaling or according to a pre-defined rule. The linkage can be used to determine UL transmission for the corresponding beams, e.g., if a many-to-1 mapping exists between the beam indications in DCI 2_0 and a TCI/SRI state, the UE may share the gNB-initiated COT for a UL transmission with a beam corresponding to the TCI/SRI state if the UL transmission is within the COT of all beams that are linked with the TCI/SRI state. The linkage can be used to determine DL reception for the corresponding beams, e.g., if a 1-to-many mapping exists between the beam indications in DCI 2_0 and a TCI state for CSI-RS reception, the UE can receive the CSI-RS with a beam corresponding to the TCI state if the DL reception is within the COT of the beam.

In this case, one of the following options may be used:

DCI 2_0 contains common information regarding slot form indicator (SFI), search space set group (SSSG) switching, and COT length, but an additional field, which can be either a new field or ‘Available RB sets’ field may be repurposed, is added to indicate the occupation status for each beam. In this matter, one of the following could be supported: a bitmap that indicates the applicability of the information to specific beam groups based on the information desired; a TCI field, which, if absent, indicates that the information carried is applied to all beams (e.g., quasi omni-directional LBT was used at the gNB); and a beam availability indicator that indicates whether or not a subset of beams are available from the list of beams for which the COT is to be applied.

DCI 2_0 contains common information regarding SFI, and SSSG switching, but the COT length information is no longer a scalar, but a vector that indicates the COT length information for each beam. For instance, the COT length information may be composed by a list of values, where each value is associated to a specific beam or group of beams. In this case, a COT length information for a beam or group of beams set to 0 is interpreted as if the gNB was not able to acquire that beam or group of beams, and COT sharing cannot occur in that direction.

DCI 2_0 contains common information regarding SFI, and SSSG switching, but the COT length information is no longer a scalar, but a vector that indicates the COT length information for a group of beams which are additionally signaled via an additional field containing a bitmap. In this case, a COT length of 0 for a beam is interpreted as if the gNB was not able to acquire that beam. For instance, the COT length information may be composed by a list of values, where each value is associated to a specific beam within a specific group of beams. The indication of the group of beams for which the COT length information is provided is indicated through a bitmap, which indicates among all beams those that belong to the group of beams.

DCI 2_0 contains information regarding SFI, SSSG switching, and COT length per beam. In this case, a COT length of 0 for a beam is interpreted as if the gNB was not able to acquire that beam.

DCI 2_0 contains information regarding common information related to SFI, but for SSSG switching, and COT length the information is provided per beam. In this case, a COT length of 0 for a beam is interpreted as if the gNB was not able to acquire that beam.

DCI 2_0 contains information for SFI, SSSG switching and COT length information. At least one of the pieces of information only applies to a group of beams that are linked with the TCI for DCI 2_0. The linkage of the group of beams and TCI for DCI 2_0 can be configured by higher layer signaling or determined by a pre-defined rule, e.g., associated with same channel state information reference signal (CSI-RS) or signaling system block (SSB), or one is associated with a CSI-RS and the other is associated with a SSB but the CSI-RS is also QCL with the SSB.

In above options, if the COT length is indicated per beam or per group of beams, the COT for different beams may start from different time but end at the same time. Alternatively, the COT for different beams may start from same time but end in the different time. Alternatively, both the start time and ending time for the COT of different beams may be different.

In the above options, if the SFI is common for multiple beams and the COT is beam or beam group specific, the indicated SFI is applicable to all beams no matter whether or not LBT for those beams is successful. On a beam with successful LBT, the gNB may share its own COT for that specific beam with a UE, which implies that the UE may either send a UL transmission without LBT (Type-3 LBT) or if configured/indicated by the gNB and capable of type 2 LBT (a.k.a. CAT-2 LBT), type 2 LBT is to be successfully performed at the UE before transmission. On the other hand, on a beam with failed LBT, a UE is to perform type 1 LBT (a.k.a Cat-4 with fixed contention window or CAT-3 LBT) if the UE is to start a UL transmission, because COT is not shared for the beam.

### Responding Device Behavior in Presence of Independent COTs Over Different Beams

In NR operating above the 52.6 GHz band, when LBT is mandated or configured to be used, a device may acquire different COTs on different beams at different instances of time by using either a wide-beam LBT or independent per-beam LBT. In either case, the exact responding device behavior when the COTs are shared and the responding device has type 2 LBT capability is to be defined.

In one embodiment, the responding device may treat each COT independently, and the device may perform type 2 LBT only in the beam(s) belonging to the COT where the transmission is to be performed if the gap with any prior transmissions in that beam(s) is larger than Y.

In another embodiment, if the gap with any prior transmissions in any of the beams for which a COT has been initiated is larger than Y, the responding device may perform type 2 LBT in all beams for which a COT has been initiated independently if some of those beams may or may not belong to the COT where the transmission is to be performed.

In another embodiment, if the gap with any prior transmissions in any of the beams for which a COT has been initiated is larger than Y, the responding device may perform type 2 LBT only in the beams belonging to the COT where the transmission should be performed.

In another embodiment, the gap between transmissions is only counted across transmissions occurring within the beam(s) belonging to the same COT.

In another embodiment, the gap between transmissions is counted across transmissions occurring within beam(s) belonging to all active COTs.

Similar to the above, some of the embodiments listed above are not mutually exclusive, and one or more of them may apply together or may be combined. In addition, a responding device may be either a UE or a gNB. Furthermore, despite the description of the embodiments above, the behavior for both the UE and gNB as the responding device may be the same or may be differ and some embodiment may apply to a type or device while other may apply to the other type of device.

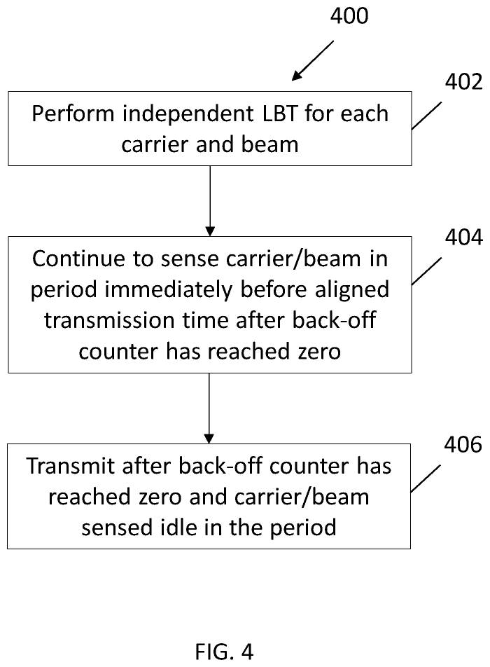

FIG. 4 illustrates reference signal transmission in accordance with some embodiments. The electronic device(s), network(s), system(s), chip(s) or component(s), or portions or implementations thereof, of the figures herein may be configured to perform one or more processes, techniques, or methods as described herein, or portions thereof. One such process is depicted in FIG. 4. The process 400 may be performed by a UE. The process may include performing, at operation 402, independent LBT for each carrier and beam; sensing, at operation 404, the carrier and beam in a period immediately before an aligned transmission time after back-off counter has reached zero; and transmitting, at operation 406, on the carrier or beam after back-off counter has reached zero and the carrier or beam has been sensed idle in the period immediately before the aligned transmission time.

### Examples

Example 1 is an apparatus for a user equipment (UE), the apparatus comprising: memory; and processing circuitry, to configure the UE to: determine that type 1 listen before talk (LBT) is to be performed in at least one of a multi-carrier or multi-beam mode; perform, for at least one of a plurality of beams or a channel that includes, a plurality of carriers above a 52.6 GHz 52.6 GHz band, the type 1 LBT to maintain and update at least one back-off counter for the at least one of plurality of carriers or beams; and send, to a 5th generation nodeB (gNB), an uplink transmission on at least one of the carriers or beams in response to success of the type 1 LBT during a channel occupancy time (COT); and wherein the memory is configured to store that at least one back-off counter.

In Example 2, the subject matter of Example 1 includes, LBT for each carrier or beam independently to independently maintain and update a different back-off counter for each carrier or beam.

In Example 3, the subject matter of Example 2 includes, wherein the processing circuitry configures the UE to align a transmission starting time of a transmission across the carriers or beams to prevent overlapping transmission on one of the carriers or beams and LBT on another of the carriers or beams respectively.

In Example 4, the subject matter of Example 3 includes, wherein to align the starting time the processing circuitry configures the UE to, for each carrier or beam: in response to determination that the back-off counter for the carrier or beam has reached zero before the transmission starting time, continue to decrement the back-off counter and sense the channel via additional observation periods after the back-off counter has reached zero before the transmission starting time and transmit in the carrier or beam at the starting time in response to a determination that the channel continues to be sensed idle in all of the additional observation periods, and in response to determination that the back-off counter for the carrier or beam has not reached zero before the transmission starting time or that the back-off counter for the carrier or beam has reached zero before the transmission starting time but the channel has been sensed busy in at least one of the additional observation periods, determine that a channel access procedure in the carrier or beam has failed.

In Example 5, the subject matter of Examples 3-4 includes, wherein to align the starting time the processing circuitry configures the UE to, for each carrier or beam: in response to determination that the back-off counter for the carrier or beam has reached zero before the transmission starting time, continue to decrement the back-off counter and sense the channel via additional observation periods after the back-off counter for the carrier or beam has reached zero before the transmission starting time and transmit in the carrier or beam at the starting time in response to a determination that the channel continues to be sensed idle for at least a predetermined number of the additional observation periods prior to the transmission starting time, and in response to determination that the back-off counter for the carrier or beam has not reached zero before the transmission starting time or that the back-off counter for the carrier or beam has reached zero before the transmission starting time but the channel has been sensed busy at least one of the predetermined number of the additional observation periods prior to the transmission starting time or in any of the additional observation periods, determine that a channel access procedure in the carrier or beam has failed.

In Example 6, the subject matter of Examples 3-5 includes, wherein to align the starting time the processing circuitry configures the UE to, for each carrier or beam: in response to determination that the back-off counter for the carrier or beam has reached zero before the transmission starting time, determine that a channel access procedure in the carrier or beam has been successful and transmit in the carrier or beam at the starting time, and in response to determination that the back-off counter for the carrier or beam has not reached zero before the transmission starting time, determine that the channel access procedure in the carrier or beam has failed.

In Example 7, the subject matter of Examples 3-6 includes, wherein to align the starting time the processing circuitry configures the UE to, for each carrier or beam: in response to determination that the back-off counter for the carrier or beam has reached zero before the transmission starting time and the channel is idle after performance of at least a predetermined number of additional observations immediately before the transmission starting time, determine that a channel access procedure in the carrier or beam has been successful and transmit in the carrier or beam at the starting time, and in response to determination that the back-off counter for the carrier or beam has not reached zero before the transmission starting time, or the back-off counter for the carrier or beam has reached zero before the transmission starting time but the channel is busy after performance of at least one of the predetermined number of additional observations immediately before the transmission starting time, determine that the channel access procedure in the carrier or beam has failed.

In Example 8, the subject matter of Example 7 includes, wherein the processing circuitry configures the UE to count a maximum channel occupancy time from one of the transmission starting time and an instance of time when at least one LBT succeeds over one of the carriers or beams.

In Example 9, the subject matter of Examples 3-8 includes, wherein to align the starting time the processing circuitry configures the UE to, for each carrier or beam: transmit in the carrier at the starting time in response to determination that the back-off counter for the carrier or beam has reached zero immediately before the transmission starting time, and otherwise determine that a channel access procedure in the carrier or beam has failed.

In Example 10, the subject matter of Examples 2-9 includes, wherein the processing circuitry configures the UE to at least one of: reinitialize the counter for all of the carriers or beams in response to cessation of transmission in any of the carriers or beams over which LBT has been performed, or for each carrier or beam over which LBT has been performed and for which transmission has ceased, reinitialize the counter for the carrier or beam.

In Example 11, the subject matter of Examples 1-10 includes, wherein the processing circuitry configures the UE to perform an independent per-beam LBT over each beam for which a COT is to be acquired for the channel, and drop a transmission in response to one of: an LBT procedure fails on at least one of the beams, or the LBT procedure fails on all of the beams, and otherwise the COT is considered to be acquired for each beam for which the independent per-beam LBT procedure succeeded.

In Example 12, the subject matter of Examples 1-11 includes, that contains control information per beam, the control information including occupation status that is provided in one of: a bitmap that indicates applicability of the control information to specific beam groups, a Transmission Configuration Indication (TCI) field, which, if absent, indicates that the control information carried is applied to all beams, and a beam availability indicator that indicates whether a subset of beams is available from a list of beams for which the COT is to be applied.

In Example 13, the subject matter of Examples 1-12 includes, that contains vector COT length information, one of: the COT length information including a first list of values in which each value is associated with a specific beam or group of beams, the COT length information for a particular beam or group of beams set to 0 to indicate that the gNB was unable to acquire the particular beam or group of beams and COT sharing is not to occur in a direction of the particular beam or group of beams, or the COT length information indicating a COT group of beams signaled via a bitmap, a COT length for a COT beam within the COT group of beams is 0 to indicate the gNB was unable to acquire the COT beam, the COT length information including a second list of values in which each value is associated with a specific COT beam within a specific group of COT beams, the group of COT beams for which the COT length information is provided being indicated through the bitmap.

In Example 14, the subject matter of Examples 1-13 includes, that contains one of: first common information related to slot form indicator (SFI) and search space set group (SSSG) switching, and per beam information including COT length per beam, a COT length for a first beam being 0 to indicate the gNB was unable to acquire the first beam, second common information related to SFI, and per beam information including SSSG switching and COT length per beam, the COT length for a second beam being 0 to indicate the gNB was unable to acquire the second beam, or SFI, SSSG switching, COT length information at least one of which only applies to a group of beams linked with a Transmission Configuration Indication (TCI) for the DCI 2_0.

In other examples, the subject matter of Examples 1-13 may apply to gNBs as well as UEs. For example, like Example 1, an apparatus for a 5th generation nodeB (gNB), the apparatus comprising: memory; and processing circuitry, to configure the gNB to: determine that type 1 listen before talk (LBT) is to be performed in at least one of a multi-carrier or multi-beam mode; perform, for at least one of a plurality of beams or a channel that includes, a plurality of carriers above a 52.6 GHz 52.6 GHz band, the type 1 LBT to maintain and update at least one back-off counter for the at least one of plurality of carriers or beams; and send, to a user equipment (UE), a downlink transmission on at least one of the carriers or beams in response to success of the type 1 LBT during a channel occupancy time (COT); and wherein the memory is configured to store that at least one back-off counter.

Example 15 is a computer-readable storage medium that stores instructions for execution by one or more processors of a user equipment (UE), the one or more processors to configure the UE to, when the instructions are executed: perform, for at least one of a plurality of beams or a channel that includes, a plurality of carriers above a 52.6 GHz band, type 1 listen before talk (LBT) independently for at least one of each carrier or each beam to maintain and update a different back-off counter for each carrier or beam; and send, to a 5th generation nodeB (gNB), an uplink transmission on at least one of the carriers or beams in response to success of the type 1 LBT during a channel occupancy time (COT).

In Example 16, the subject matter of Example 15 includes, wherein: the instructions, when executed by the one or more processors, configure the UE to align a transmission starting time of a transmission across the carriers or beams to prevent overlapping transmission on one of the carriers or beams and LBT on another of the carriers or beams respectively, and to align the starting time the instructions, when executed by the one or more processors, configure the UE to, for each carrier or beam: in response to determination that the back-off counter for the carrier or beam has reached zero before the transmission starting time, continue to decrement the back-off counter and sense the channel via an additional observation period immediately prior to the transmission starting time after the back-off counter for the carrier or beam has reached zero before the transmission starting time and transmit in the carrier or beam at the starting time in response to a determination that the channel continues to be sensed idle for the additional observation period, and in response to determination that the back-off counter for the carrier or beam has not reached zero before the transmission starting time or that the back-off counter for the carrier or beam has reached zero before the transmission starting time but the channel has been sensed busy for the additional observation periods, determine that a channel access procedure in the carrier or beam has failed.

In Example 17, the subject matter of Example 16 includes, wherein the instructions, when executed by the one or more processors, configure the UE to reinitialize the counter for all of the carriers or beams in response to cessation of transmission in any of the carriers or beams over which LBT has been performed.

Example 18 is an apparatus for a 5th generation nodeB (gNB), the apparatus comprising: memory; and processing circuitry, to configure the gNB to: perform, for at least one of a plurality of beams or a channel that includes, a plurality of carriers above a 52.6 GHz band, type 1 listen before talk (LBT) independently for at least one of each carrier or each beam to maintain and update a different back-off counter for each carrier or beam; and send, to a user equipment (UE), downlink transmission on at least one of the carriers or beams in response to success of the type 1 LBT during a channel occupancy time (COT); and wherein the memory is configured to store that at least one back-off counter.

In Example 19, the subject matter of Example 18 includes, wherein the processing circuitry configures the gNB to: align a transmission starting time of a transmission across the carriers or beams to prevent overlapping transmission on one of the carriers or beams and LBT on another of the carriers or beams respectively, and for each carrier or beam: in response to determination that the back-off counter for the carrier or beam has reached zero before the transmission starting time, continue to decrement the back-off counter and sense the channel via an additional observation period immediately prior to the transmission starting time after the back-off counter for the carrier or beam has reached zero before the transmission starting time and transmit in the carrier or beam at the starting time in response to a determination that the channel continues to be sensed idle for the additional observation period, and in response to determination that the back-off counter for the carrier or beam has not reached zero before the transmission starting time or that the back-off counter for the carrier or beam has reached zero before the transmission starting time but the channel has been sensed busy for the additional observation periods, determine that a channel access procedure in the carrier or beam has failed.

In Example 20, the subject matter of Example 19 includes, wherein the processing circuitry configures the gNB to reinitialize the counter for all of the carriers or beams in response to cessation of transmission in any of the carriers or beams over which LBT has been performed.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-40. (canceled)

41. An apparatus for a user equipment (UE), the apparatus comprising:
processing circuitry configured to:
determine that the UE is to transmit a transmission in frequency range (FR) 2-2 that is to start at a same time on each channel of a set of channels;
after a determination that that the transmission in FR 2-2 is to start at the same time on each channel of the set of channels, perform channel access procedures on each channel independently; and
in response to sensing that a first channel of the set of channels is idle, encode the transmission for transmission in FR 2-2 within a channel occupancy on the first channel of the set of channels; and
memory configured to store data of the transmission.

42. The apparatus of claim 41, wherein the channel access procedures are Type 1 channel access procedures.

43. The apparatus of claim 42, wherein to perform sensing on the set of channels, the processing circuitry is configured to use a single sensing beam that covers all transmissions beams.

44. The apparatus of claim 42, wherein the processing circuitry is configured to perform simultaneous sensing in different sensing beams to perform sensing on the set of channels, each sensing beam covering a different transmission beam.

45. The apparatus of claim 41, wherein the processing circuitry is configured to initialize a counter for each channel independently and perform sensing on each channel after an end of a previous transmission occupying the channel.

46. The apparatus of claim 45, wherein the processing circuitry is configured to encode the transmission on a particular channel after first sensing the particular channel to be idle during a sensing slot duration and after the counter for the particular channel is zero.

47. The apparatus of claim 46, wherein the processing circuitry is configured to:
initialize the counter for the particular channel to a random number; and
start a loop to:
determine whether the counter for the particular channel is zero; and
in response to the counter being larger than zero:
decrement the counter for the particular channel;
sense the particular channel for a sensing slot duration and, in response to
a determination that the particular channel is idle for the sensing slot duration, return to determining whether the counter for the particular channel is zero; and
in response to a determination that the particular channel is not idle for the sensing slot duration:
sense the particular channel until either the particular channel is detected to be busy within a defer duration or idle for a sensing slot of the defer duration;
in response to a determination that the particular channel is idle for the sensing slot of the defer duration, return to determining whether the counter for the particular channel is zero; and
in response to a determination that the particular channel is not idle for the sensing slot of the defer duration, return to sensing the particular channel until either the particular channel is detected to be busy within an additional defer duration or idle for a sensing slot of the additional defer duration.

48. The apparatus of claim 47, wherein the defer duration is 8 μs and the sensing slot duration is 5 μs.

49. The apparatus of claim 41, wherein the processing circuitry is configured to:
decode downlink control information (DCI) that schedules the transmission, the DCI indicating a corresponding channel access procedure for the transmission; and
determine, based on the DCI, whether to use a Type 1 channel access procedure for each of the corresponding channel access procedures.

50. A non-transitory computer-readable storage medium that stores instructions for execution by one or more processors of a user equipment (UE), the one or more processors configured to, when the instructions are executed:
determine that the UE is to transmit a transmission in frequency range (FR) 2-2 that is to start at a same time on each channel of a set of channels;
after a determination that that the transmission in FR 2-2 is to start at the same time on each channel of the set of channels, perform channel access procedures on each channel independently; and
in response to sensing that a first channel of the set of channels is idle, encode the transmission for transmission in FR 2-2 within a channel occupancy on the first channel of the set of channels.

51. The non-transitory computer-readable storage medium of claim 50, wherein the channel access procedures are Type 1 channel access procedures.

52. The non-transitory computer-readable storage medium of claim 51, wherein to perform sensing on the set of channels, the one or more processors are configured to, when the instructions are executed, use a single sensing beam that covers all transmissions beams.

53. The non-transitory computer-readable storage medium of claim 51, wherein the one or more processors are configured to, when the instructions are executed, perform simultaneous sensing in different sensing beams to perform sensing on the set of channels, each sensing beam covering a different transmission beam.

54. The non-transitory computer-readable storage medium of claim 50, wherein the one or more processors are configured to, when the instructions are executed, initialize a counter for each channel independently and perform sensing on each channel after an end of a previous transmission occupying the channel.

55. The non-transitory computer-readable storage medium of claim 54, wherein the one or more processors are configured to, when the instructions are executed:
encode the transmission on a particular channel after first sensing the particular channel to be idle during a sensing slot duration and after the counter for the particular channel is zero;
initialize the counter for the particular channel to a random number; and
start a loop to:
determine whether the counter for the particular channel is zero; and
in response to the counter being larger than zero:
decrement the counter for the particular channel;
sense the particular channel for a sensing slot duration and, in response to a determination that the particular channel is idle for the sensing slot duration, return to determining whether the counter for the particular channel is zero; and
in response to a determination that the particular channel is not idle for the sensing slot duration:
sense the particular channel until either the particular channel is detected to be busy within a defer duration or idle for a sensing slot of the defer duration;
in response to a determination that the particular channel is idle for the sensing slot of the defer duration, return to determining whether the counter for the particular channel is zero; and
in response to a determination that the particular channel is not idle for the sensing slot of the defer duration, return to sensing the particular channel until either the particular channel is detected to be busy within an additional defer duration or idle for a sensing slot of the additional defer duration.

56. The non-transitory computer-readable storage medium of claim 55, wherein the defer duration is 8 μs and the sensing slot duration is 5 μs.

57. The non-transitory computer-readable storage medium of claim 50, wherein the one or more processors are configured to, when the instructions are executed:
decode downlink control information (DCI) that schedules the transmission, the DCI indicating a corresponding channel access procedure for the transmission; and
determine, based on the DCI, whether to use a Type 1 channel access procedure for each of the corresponding channel access procedures.

58. A communication system comprising:
an antenna;
baseband processing circuitry configured to:
determine that a user equipment (UE) of the communication system is to transmit a transmission in frequency range (FR) 2-2 that is to start at a same time on each channel of a set of channels;
after a determination that that the transmission in FR 2-2 is to start at the same time on each channel of the set of channels, perform channel access procedures on each channel independently; and
in response to sensing that a first channel of the set of channels is idle, encode the transmission for transmission in FR 2-2 within a channel occupancy on the first channel of the set of channels; and
memory configured to store data of the transmission.

59. The communication system of claim 58, wherein the channel access procedures are Type 1 channel access procedures.

60. The communication system of claim 59, wherein the baseband processing circuitry is configured to:
initialize a counter for each channel independently and perform sensing on each channel after an end of a previous transmission occupying the channel;
encode the transmission on a particular channel after first sensing the particular channel to be idle during a sensing slot duration and after the counter for the particular channel is zero;
initialize the counter for the particular channel to a random number; and
start a loop to:
determine whether the counter for the particular channel is zero; and
in response to the counter being larger than zero:
decrement the counter for the particular channel;
sense the particular channel for a sensing slot duration and, in response to a determination that the particular channel is idle for the sensing slot duration, return to determining whether the counter for the particular channel is zero; and
in response to a determination that the particular channel is not idle for the sensing slot duration:
sense the particular channel until either the particular channel is detected to be busy within a defer duration or idle for a sensing slot of the defer duration;
in response to a determination that the particular channel is idle for the sensing slot of the defer duration, return to determining whether the counter for the particular channel is zero; and
in response to a determination that the particular channel is not idle for the sensing slot of the defer duration, return to sensing the particular channel until either the particular channel is detected to be busy within an additional defer duration or idle for a sensing slot of the additional defer duration.
